(19) United States
(12) Patent Application Publication
(10) Pub. No.: US 2026/0178365 A1
(43) Pub. Date: Jun. 25, 2026

(54) AUTOMATED DISCOVERY OF HIDDEN IDENTIFIERS WITHIN APPLICATION CONTAINERS

(71) Applicant: T-MOBILE INNOVATIONS LLC, Overland Park, KS (US)

(72) Inventors: Raghavendra KULKARNI, Sammamish, WA (US); Sudhanshu PANDEY, Sammamish, WA (US)

(21) Appl. No.: 19/000,231

(22) Filed: Dec. 23, 2024

(51) Int. Cl. G06F 9/455; H04L 41/12

(52) U.S. Cl. CPC G06F 9/45558; H04L 41/12; G06F 2009/45595

(57) ABSTRACT

Aspects herein capture methods, media, devices, and systems automated Internet Protocol (IP) discovery within overlaid applications. To achieve this, a request is generated, and the request is a computerized command for performance by an application programming interface (API). The generated request is then communicated to the API. The API is associated with a stack (e.g., a Kubernetes stack), and the request automatically causes the API to retrieve attributes, including IPs, that correspond to containers associated with an application in the stack. These attributes are then received. In response to receiving the attributes, the attributes are communicated to a configuration management database deployed in a telecommunication network. This database is configured to allow users to assign ownership to each IP corresponding to each container associated with the application.

### TECHNICAL BACKGROUND

The present disclosure generally relates to telecommunication networks.

### SUMMARY

A high-level overview of various aspects of the disclosure is provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

In one aspect, a method for automated Internet Protocol (IP) discovery within overlaid applications is provided. In accordance with the method, a request is generated, wherein the request is a computerized command for performance by an application programming interface (API). The request is communicated to the API, wherein the API is associated with a stack, and wherein the request automatically causes the API to retrieve attributes that comprise a plurality of IPs that correspond to a plurality of containers associated with a function application. The attributes that comprise the plurality of IPs that correspond to the plurality of containers associated with the function application are received. Then, in response to receiving the attributes, the attributes are communicated to a database deployed in a telecommunication network, wherein the database is configured for assigning ownership to each of the plurality of IPs that correspond to the plurality of containers associated with the function application.

In another aspect, one or more non-transitory computer-readable media storing instructions are provided that, when executed via one or more processors, perform a computerized method for IP discovery. In accordance with the media, a request is generated, wherein the request is a computerized command for performance by an API. The request is communicated to the API, wherein the API is associated with a stack, and wherein the request automatically causes the API to retrieve attributes that comprise a plurality of IPs that correspond to a plurality of containers associated with a function application. The attributes that comprise the plurality of IPs that correspond to the plurality of containers associated with the function application are received. Then, in response to receiving the attributes, the attributes are communicated to a database deployed in a telecommunication network, wherein the database is configured for assigning ownership to each of the plurality of IPs that correspond to the plurality of containers associated with the function application.

In yet another aspect, a system for IP address identification for containers is provided. The system comprises a physical server rack comprised of a plurality of servers, each of the plurality of servers comprising a host level operating system and a plurality of containers, wherein the physical server rack is deployed in a telecommunication network. The system also comprises a discovery application and one or more processors. The discovery application is configured to, via the one or more processors, generate a request, wherein the request is a computerized command for performance by an API. The discovery application is configured to communicate the request to the API, wherein the API is associated with a stack, wherein the request automatically causes the API to retrieve attributes that comprise a plurality of IPs that correspond to a plurality of containers associated with a function application. The discovery application is configured to receive the attributes that comprise the plurality of IPs that correspond to the plurality of containers associated with the function application. In response to receiving the attributes, the discovery application is configured to communicate the attributes to a database deployed in a telecommunication network, wherein the database is configured for assigning ownership to each of the plurality of IPs that correspond to the plurality of containers associated with the function application.

### BRIEF DESCRIPTION OF THE DRAWINGS

Aspects are described in detail below with reference to the attached figures, wherein:

FIG. 1 depicts an example of a system environment in accordance with aspects;

FIG. 2 depicts an example of a rack environment in accordance with aspects;

FIG. 3 depicts an example of a function application in accordance with aspects;

FIG. 4 is a flowchart for an example method in accordance with aspects; and

FIG. 5 is an example device suitable for use in implementations of the disclosure.

### DETAILED DESCRIPTION

The subject matter of the present disclosure is being described with specificity herein to meet statutory requirements. However, the description itself is not intended to limit the scope of this patent. Rather, the inventors have contemplated that the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale and which are not to be construed as limiting. Indeed, the present disclosure can be embodied in many different forms and should not be construed as limited to the aspects set forth herein.

Throughout this disclosure, several acronyms and shorthand notations are used to aid the understanding of certain concepts pertaining to the associated system and services. These acronyms and shorthand notations are intended to help provide an easy methodology of communicating the ideas expressed herein and are not meant to limit the scope of the present disclosure. The following is a list of these acronyms:

| | |
|---|---|
| 3G | Third-Generation Wireless Access Technology |
| 4G | Fourth-Generation Wireless Access Technology |
| 5G/5G NR | Fifth-Generation Wireless Access Technology/New |
| | Radio |
| 5GC | Fifth-Generation Wireless Access Technology Core |
| | Network |
| AAU | Active Antenna Unit |
| BRS | Broadband Radio Service |
| CD-ROM | Compact Disk Read Only Memory |
| CDMA | Code Division Multiple Access |
| CU | Central Unit |
| DU | Distribution Unit |
| EIRP | Equivalent Isotropically Radiated Power |
| eNodeB | Evolved Node B |
| EVDO | Evolution-Data Optimized |
| GIS | Geographic/Geographical/Geospatial Information |
| | System |
| gNodeB/gNB | Next Generation Node B |
| gNB CU | Next Generation Node B Central Unit |
| gNB DU | Next Generation Node B Distribution Unit |
| GPRS | General Packet Radio Service |
| GSM | Global System for Mobile Communication |
| iDEN | Integrated Digital Enhanced Network |
| DVD | Digital Versatile Disc |
| EEPROM | Electrically Erasable Programmable Read-Only Memory |
| FD-MIMO | Full Dimension Multiple-Input Multiple-Output |
| IOT | Internet of Things |
| IIOT | Industry Internet of Things |
| LED | Light Emitting Diode |
| LTE | Long Term Evolution |
| MEC | Mobile Far Edge Computer |
| MD | Mobile Device |
| MIMO | Multiple-Input Multiple-Output |
| mMIMO | Massive Multiple-Input Multiple-Output |
| MMU | Massive Multiple-Input Multiple-Output Unit |
| mmWave | Millimeter Wave |
| NEXRAD | Next-Generation Radar |
| NR | New Radio |
| OOBE | Out-of-Band-Emission |
| OTN | Optical Transport Network |
| PC | Personal Computer |
| PCS | Personal Communications Service |
| PDA | Personal Digital Assistant |
| PLMN | Public Land Mobile Network |
| PRB | Physical Resource Block |
| vPRB | Virtualized Physical Resource Block |
| RAN | Radio Access Network |
| RAM | Random Access Memory |
| RET | Remote Electrical Tilt |
| RF | Radio-Frequency |
| RFI | Radio-Frequency Interference |
| RIC | Radio Intelligent Controller |
| RLF | Radio Link Failure |
| R/N | Relay Node |
| RNR | Reverse Noise Rise |
| ROM | Read-Only Memory |
| RRU | Remote Radio Unit |
| RSRP | Reference Signal Receive Power |
| RSRQ | Reference Signal Receive Quality |
| RSSI | Received Signal Strength Indicator |
| RU | Radio Unit |
| SINR | Signal-to-Interference-&-Noise Ratio |
| SNR | Signal-to-Noise Ratio |
| SON | Self-Organizing Networks |
| TDMA | Time Division Multiple Access |
| TXRU | Transceiver (or Transceiver Unit) |
| UE | User Equipment |
| UMTS | Universal Mobile Telecommunications System |
| UTRAN | UMTS Radio Access Network |
| E-UTRAN | Evolved Universal Mobile Telecommunications System |
| WCD | Wireless Communication Device (interchangeable with |
| | UE) |
| WLAN | Wireless Local Area Network |
| XR | Extended Reality |

Further, various technical terms are used throughout this description. An illustrative resource that fleshes out various aspects of these terms can be found in Newton's Telecom Dictionary, 25th Edition (2009).

Aspects herein may be embodied as, among other things: a method, system, or set of instructions embodied on one or more computer-readable media. Aspects may take the form of a hardware aspect or an aspect combining software and hardware. Some aspects may take the form of a computer program product that includes computer-useable or computer-executable instructions embodied on one or more computer-readable media.

### Definitions

“Computer-readable media” can be any available media and may include volatile and non-volatile media, as well as removable and non-removable media. By way of example, and not limitation, computer-readable media may include computer storage media and communication media. Computer-readable media may include both volatile and non-volatile media, removable and non-removable media, and may include media readable by a database, a switch, and various other network devices. Computer-readable media includes media implemented in any way for storing information. Examples of stored information include computer-useable instructions, data structures, program modules, and other data representations.

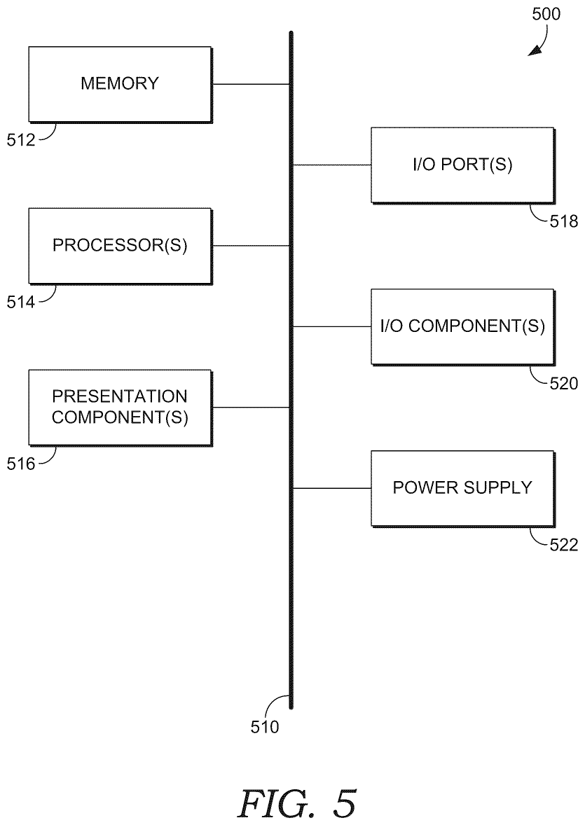

“Computer storage media” may include, without limitation, volatile and non-volatile media, as well as removable and non-removable media, implemented in any method or technology for the storage of information, such as computer-readable instructions, data structures, program modules, or other data. In this regard, computer storage media may include, but is not limited to, RAM, ROM, Electrically Erasable Programmable Read-Only Memory (EEPROM), flash memory or other memory technology, CD-ROM, DVD, holographic media, other optical disk storage, magnetic cassettes, magnetic tape, magnetic disk storage or other magnetic storage device, or any other medium that can be used to store the desired information and which may be accessed by the computing device 500 shown in FIG. 5. These technologies can store data momentarily, temporarily, or permanently.

“Communication media” may include, without limitation, computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner so as to encode information in the signal. By way of example, and not limitation, communication media includes wired media such as a wired network or direct-wired connection and wireless media such as acoustic, radio frequency (RF), infrared, and other wireless media. Combinations of any of the above may also be included within the scope of computer-readable media.

The term “application” refers to software, a computer program, and/or an API that may be run by executing, by a processor, computer-readable instructions stored on memory for running the software. Applications may operate to, for example, perform network functions, such as routing, firewalling, or load balancing, within a telecommunications network.

“Network” refers to a network comprised of wireless and wired components that provide wireless communications service coverage, for example, to one or more user devices. For example, the network may include one or more, or a plurality of, wireless networks, hardwired networks, telecommunications networks, peer-to-peer networks, distributed networks, and/or any combination thereof. The network may comprise one or more access points, one or more cell sites (i.e., managed by an access point), one or more structures such as cell towers (i.e., having an antenna) associated with each access point and/or cell site, a gateway, a backhaul data center, a server that connects two or more access points, a database, a power supply, sensors, and other components not discussed herein, in various aspects. Examples of a network include a telecommunications network (e.g., 3G, 4G, 5G, CDMA, CDMA 1XA, GPRS, EVDO, TDMA, GSM, LTE, and/or LTE Advanced) and/or a satellite network (e.g., Low Earth Orbit [LEO], Medium Earth Orbit [MEO], or geostationary). Additional examples of a network include a wide area network (WAN), a local area network (LAN), a metropolitan area network (MAN), a wide area local network (WLAN), a personal area network (PAN), a campus-wide network (CAN), a storage area network (SAN), a virtual private network (VPN), an enterprise private network (EPN), a home area network (HAN), a Wi-Fi network, a Worldwide Interoperability for Microwave Access (WiMAX) network, and/or an ad hoc (mesh) network. The network may include or may communicate with a physical location component for determining a geographic location of an item, package, parcel, personnel, vehicle, endpoint location, etc., by leveraging, for example, a Global Positioning System (GPS), Global'naya Navigatsionnaya Sputnikovaya Sistema (GLONASS), BeiDou Navigation Satellite System (BDS), Global Navigation Satellite System (GNSS or “Galileo”), an indoor position system (IPS), or other positioning systems that leverage non-GPS signals or networks (e.g., signals of opportunity [SOP]).

“User equipment” (UE), “user device,” “mobile device,” and “wireless communication device” are used interchangeably to refer to a device having hardware and software that is employed by a user in order to send and/or receive electronic signals/communication over one or more networks, whether terrestrial or aerospace. User devices generally include one or more antennas coupled to a radio for exchanging (e.g., transmitting and receiving) transmissions with an in-range base station that also has an antenna or antenna array. In aspects, user devices may constitute any variety of devices, such as a personal computer, a laptop computer, a tablet, a netbook, a mobile phone, a smartphone, a personal digital assistant, a wearable device, a fitness tracker, or any other device capable of communicating using one or more resources of the network. User devices may include components such as software and hardware, a processor, a memory, a display component, a power supply or power source, a speaker, a touch-input component, a keyboard, and the like. In various examples or scenarios that may be discussed herein, user devices may be capable of using 5G technologies with or without backward compatibility to prior access technologies, although the term is not limited so as to exclude legacy devices that are unable to utilize 5G technologies, for example.

A “containerized application” is a software application packaged with all its dependencies, libraries, and configuration files into a single, isolated unit called a container. These containers can run consistently across different computing environments, whether on a laptop, a server, in the cloud, or any other environment capable of running one or more containers. Containers ensure that the application behaves in the same way regardless of where it is deployed.

“Kubernetes” is an open-source platform that automates the deployment, scaling, and management of containerized applications.

A “cluster” is a set of node machines for running containerized applications and consists of a control plane (e.g., master nodes, which manages the cluster's overall state), worker nodes (e.g., which run the applications), pods (e.g., defined below), services (e.g., how to access the pods, often used to expose applications to the network), and volumes (e.g., persistent storage for pods). An example of a cluster is a Kubernetes cluster. For example, Kubectl is a command-line tool that is used for managing Kubernetes clusters, allowing users to interact with Kubernetes clusters and perform operations like deploying applications, inspecting and managing cluster resources, and viewing logs.

A “stack” is a collection of tools and technologies used to manage and deploy containerized applications. For example, a stack may be a Kubernetes stack, which may include a Kubernetes cluster (e.g., master and worker nodes), a container runtime, networking tools, monitoring and logging tools, and service mesh tools.

“Pods” are deployable units representing a group of one or more containers that share storage, network resources, and a specification for how to run the containers. In one example, pods may be specific to Kubernetes architecture. For example, each pod runs on a node in the Kubernetes cluster and can contain multiple tightly coupled containers that work together, though it's common for a pod to run a single container. Pods provide a shard context for their containers, including shared namespaces and filesystem volumes, which allows for efficient communication and resource sharing. In some instances throughout this detailed description, the terms “pods” and “containers” may be used interchangeably.

A “cloud-native network function” (CNF) is a software application designed to perform network functions, such as routing, firewalling, or load balancing, within a cloud-native environment. Unlike traditional network functions that run on dedicated hardware or virtual machines (VMs), CNFs are containerized and orchestrated using platforms like Kubernetes. This approach allows CNFs to benefit from cloud-native principles, including scalability, flexibility, and resilience. CNFs can be easily deployed, managed, and updated, making them ideal for modern, dynamic network environments.

A “cloud-native operations” (CNO) (e.g., also referred to as cloud native orchestration) refers to the management and coordination of cloud-native applications, which are designed to leverage cloud environments for scalability, resilience, and efficiency. Kubernetes is a prime example of a CNO as it automates the deployment, scaling, and management of containerized applications, ensuring they run smoothly across various cloud infrastructures.

A “configuration management database” (CMDB) is a centralized repository used to store information about an organization's information technology (IT) assets, commonly referred to as configuration items. These items can include hardware, software, systems, facilities, and even personnel. The CMDB helps track the state and relationships of these assets, providing a comprehensive view of the IT environment

Additionally, it will be understood that sequential or relative terms such as “first,” “second,” and “third” are used herein for the purposes of clarity in distinguishing between elements or features, but the terms are not used herein to import, imply, or otherwise limit the relevance, importance, quantity, technological functions, physical or temporal sequence, physical or temporal order, and/or operations of any element or feature unless specifically and explicitly stated as such.

### Overview

Aspects herein include a system, method, and media for automated Internet Protocol (IP) discovery within overlaid applications. In the telecommunications space, there is a push for cyber security compliance. Asset management in cybersecurity involves identifying the owner of each asset, application, node, IP, and/or other components associated with a network. It may be beneficial for cyber security compliance if each and every IP that is “live” is documented and accounted for. Accordingly, the ability to identify the owner of IP is important in driving cybersecurity compliance in asset management.

Asset data discovery involves different methods based on the type of asset involved. In some instances, IP addresses or “IPs” are a key attribute in identifying an asset, including servers associated with the IPs. In general, analyzing servers themselves is a relatively simple task, because known mechanisms (e.g., services) exist that may discover servers. For example, some mechanisms employ a system that scans through a service account associated with a server, taking information associated with the account, storing that information in a database, and using that stored information to generate display of that information for a user to review.

Because telecommunications applications are moving towards containerization deployments, identifying the IP on a pod has become ideal for holistic asset management. The information on pods in a cluster is important as there are potentially thousands of IPs that could go undiscovered, impacting cybersecurity compliance. Some asset data discovery methods have been able to discover applications, services, deployments, and replicate sets, among other components, on servers associated with a cluster. However, discovering IPs within containers has been difficult, if not impossible, to achieve.

The present disclosure includes systems, methods, and media for automated IP discovery within overlaid applications (e.g., overlaid applications are containerized applications). To achieve this, a specialized request that is a computerized command for performance by an application programming interface (API) is automatically generated by an application external to the overlaid application. The request is communicated to the API, where the API is a target containerized application. The API is associated with a stack (e.g., a Kubernetes stack), and the request automatically causes the API to retrieve attributes, including IPs, from a containerized application (e.g., a CNF). In other words, the IPs within the containers of the containerized application are retrieved at the direction of the specialized request being executed by the API. These attributes are received by a function application (e.g., by a CNO). In response to receiving the attributes, the attributes are communicated from the function application to a database (e.g., a CMDB) deployed in a telecommunication network. This database is configured for assigning ownership to each IP discovered as corresponding to various containers, said containers associated with the containerized application.

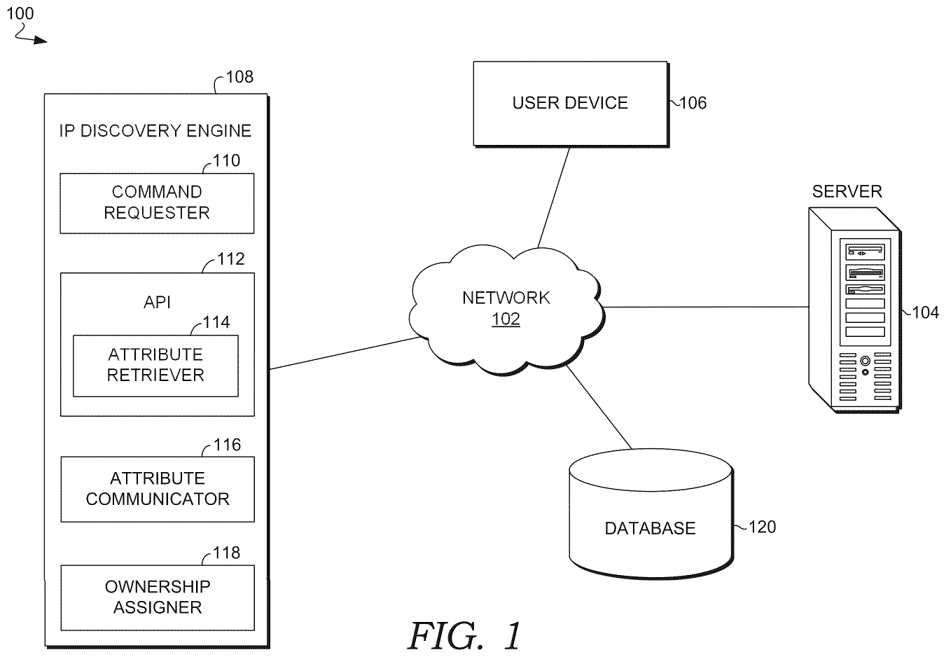

Beginning with FIG. 1, FIG. 1 depicts an example of a network environment 100 in accordance with one or more aspects. It will be understood by those of ordinary skill in the art that the network environment 100 is just one example of a suitable environment for implementing systems, media, and methods described herein that is not intended to limit the scope of use or functionality of the present disclosure. The example network environment 100 is simplified to illustrate devices, components, and modules in merely one of many suitable configurations and arrangements, such that configurations and arrangements of devices, components, and modules relative to one another, as well as the quantity of each of the devices, components, and modules, can vary from what is depicted (e.g., devices, components, and modules may be omitted and/or could be greater in quantity than shown). As such, the absence of components from FIG. 1 should be not be interpreted as limiting the present disclosure to exclude additional components and combination(s) of components. Similarly, the network environment 100 should not be interpreted as imputing any dependency between devices, components, and modules, and nor should it be interpreted as imputing any requirements with regard to each of the devices, components, modules, and combination(s) of such, as illustrated in FIG. 1. Also, it will be appreciated by those having ordinary skill in the art that the connections illustrated in FIG. 1 are also examples as other methods, hardware, software, and devices for establishing a communications link between the components, devices, systems, and entities, as shown in FIG. 1, may be utilized in implementations of the present disclosure. Although the connections are depicted using one or more solid lines, it will be understood by those having ordinary skill in the art that the examples of connections of FIG. 1 may be hardwired or wireless, and may use intermediary components that have been omitted or not included in FIG. 1 for simplicity's sake.

As shown in FIG. 1, the network environment 100 includes a network 102, a server 104, a user device 106, a database 120, and an IP discovery engine 108. In aspects, the network 102 is a telecommunications network having a plurality of access points that provide service to a plurality of user devices, such as the user device 106. The user device 106 may be any UE and/or computing device, such as computing device 500. The server 104 and the database 120 operate within the network 102, and as further discussed, can provide services to users via the IP discovery engine 108 and the user device 106, in order to promote cyber security with the network 102.

In some aspects, the server 104 may be a virtual server that operates in a cloud computing environment, and which is supported by individual server(s) in data centers. In some instances, the server 104 may be a physical server that operates within one or more data centers. In aspects, although a cloud-based server 104 may be discussed herein, it will be understood that server platforms that are partially cloud-based or are not cloud-based may be utilized and leveraged, whether alone or in connection with a cloud-based server, to perform aspects discussed herein. Each server 104 may have its own operating system (OS). The database 120 can operate as cloud-based storage that supports the server 104 in a cloud computing environment as shown, or it may instead be partially cloud-based or not cloud-based, in various aspects.

The IP discovery engine 108 of FIG. 1 facilitates the automated discovery of IP within overlaid applications. To achieve this, the IP discovery engine 108 includes a command requester 110, an application programming interface (API) 112, an attribute retriever 114, an attribute communicator 116, and an ownership assigner 118. In some aspects, the IP discovery engine 108 is an asset data discovery service. In some aspects, the IP discovery engine 108, including the command requester 110, the API 112, the attribute retriever 114, the attribute communicator 116, and the ownership assigner 118, may be software (e.g., computer executable code, applications, modules, etc.) and or computer-readable media that facilitate the automated discovery of IP within overlaid applications.

The command requester 110 may send a request to the server 104 asking for attributes of a cluster. The command requester 110 may communicate with a stack through the API 112 to request the attributes of any given cluster associated with the server 104. In some instances, the request communicated by the command requester 110 may be sent automatically, although the request may be generated and communicated manually or in response to a trigger or prompt.

The API 112 facilitates receiving the request sent from the command requester 110 and facilitates retrieving the attributes corresponding to the request via the attribute retriever 114. In some aspects, the API 112 is associated with a stack. In some instances, the API 112 is associated with the database 120 and/or the server 104 that is dedicated to the API 112. In examples in which the API 112 has a dedicated database and/or a server, the database and/or server keep the API 112 informed of all systems, such as servers hosting or running applications, in the stack. As such, the command requester 110 may reach out to the API 112 server and request from the API 112 a list of IPs that are residing in the pods, said pods being within a container or a plurality of containers within the servers in the stack. In other words, the command requester 110 sends one or more calls to the API 112 to request information related to the pods. In some aspects, the call is a Kubectl command that actually causes the API 112 or a component associated therewith, upon being received by the API 112, to execute the Kubectl command, which includes specialized instructions for discovering IPs in the pods, said IPs being hidden within the pods(s) inside the container(s).

In such an instance, the request sent from the command requester 110 to the API 112 may automatically cause the attribute retriever 114 that is associated with the API 112 to retrieve attributes of a cluster, specifically to retrieve the hidden IPs within the containers, and pods therein, of a containerized application. In some aspects, the containerized application may be a CNF.

Once the attributes are received (e.g., at a CNO), the attribute communicator 116 of the IP discovery engine 108 may communicate the attributes to the database 120 deployed in the network 102, whether physical or within a cloud. In some aspects, the database 120 is a CMDB. According to one such aspect, the attribute communicator 116 may publish the received attributes to a cloud-based CMDB that is configured to allow ownership to be assigned, whether manually, automatically, or when triggered, to each IP corresponding to each container (e.g., of the Kubernetes pods) associated with the containerized application. This creates visibility and discovery of IPs that were otherwise undiscoverable and hidden, and which could be tracked or monitored in a manner that thwarted cyber security needs.

The ownership assigner 118, in some aspects, allows asset- and/or application-owners to claim ownership of the discovered IPs corresponding to each container and/or to pod(s) within container(s). In other words, the ownership assigner 118 may list the ownership for each IP stored in the database that was communicated by the attribute communicator 116. According to aspects, an asset- and/or application-owner, or another party such as a mobile network operator (MNO), may review the list of ownership and determine, manually or via specialized software, whether there are further steps that should be taken for cybersecurity compliance within the network 102.

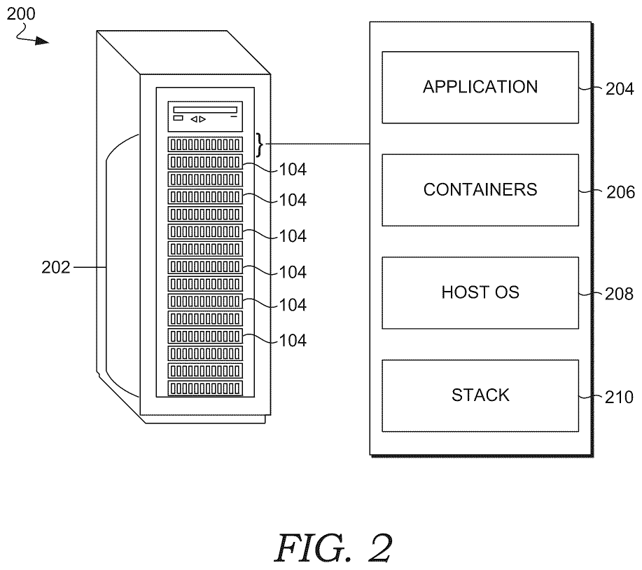

With reference now to FIG. 2, FIG. 2 depicts an example of a rack deployed within a network environment in accordance with aspects herein. As illustrated, a rack 202 includes a plurality of servers 104. In the example shown in FIG. 2, the rack 202 is a physical server rack. According to various aspects, each server 104 may include one or more applications 204, one or more containers 206 for each of the one or more applications 204, a host level OS 208, and a stack 210.

The application 204 is shown as singular for simplicity, but the rack 202 may operate to host a vast quantity of applications (e.g., tens, hundreds, or thousands) at any given time. In one example, the application 204 is a containerized application, meaning that the application overlays a plurality of containers. The containers 206 may communicate with each other, within a single application to which the container “belong” or are associated with. In some aspects, one or more of the containers 206 may be comprised of Kubernetes pods. The Kubernetes pods in such containers are dynamic (i.e., are not static) and may be continuously changing, as will be understood by those of skill in the art in view of this Description. In some aspects, the containers 206 of the application 204 may be in binary and comprise a library (e.g., stored information in any type of data structure). Each container 206 within a single containerized application may be associated with and stored with multiple IPs. For example, each pod in one container may have a unique IP for that pod, so that a container having a plurality of pods includes a plurality of IPs that can be used to uniquely identify each pod. In one example, there may be one particular type of IP (e.g., such as a unique IP address) associated with one or more of the containers 206, or there may be more than one particular type of IP associated with the one or more containers 206. The IPs within the pods and/or within the containers are hidden until discovered by the aspects described herein.

Returning to FIG. 2, each OS that corresponds to each server 104 in the rack 202 may be combined to form the host OS 208. In some aspects, the host OS 208 is a LINUX host OS. The host OS 208 may include a layer of structure that enables the use of a host level service account on the host OS 208. According to aspects, the host OS 208 sits on a number of servers (e.g., such as the servers 104 in the rack 202), allowing the host OS 208 to individually control each server 104 (e.g., facilitate their operations and other forms of control).

Each server 104 may be independent of the other servers. Each server 104 may have an externally facing IP that can be used by the host OS 208 of the servers 104. For example, the organization of the servers 104 may be optimized by organizing each stack 210 (e.g., a Kubernetes stack) in each server on the rack 202. The optimized stack re-organization, whether manually or automatically performed, allows an MNO to define the capacity of the pods, containers, and/or clusters with each of the one or more applications 204, which in turn optimizes each stack 210 for each server, and each server within the rack 202.

In some examples, the stack 210 is a collection of tools and technologies used to manage and deploy the application 204 with Kubernetes. As an intrinsic property of the stack 210, the stack 210 may maintain a list of its attributes and parts which are running in a local database. For example, when a particular application 204 is spawned, the attributes of that specific application 204 may be saved to the stack 210 (e.g., as part of a Kubernetes cluster), and further, the information related to the application 204 (e.g., information related to the Kubernetes cluster) may be stored on a local database.

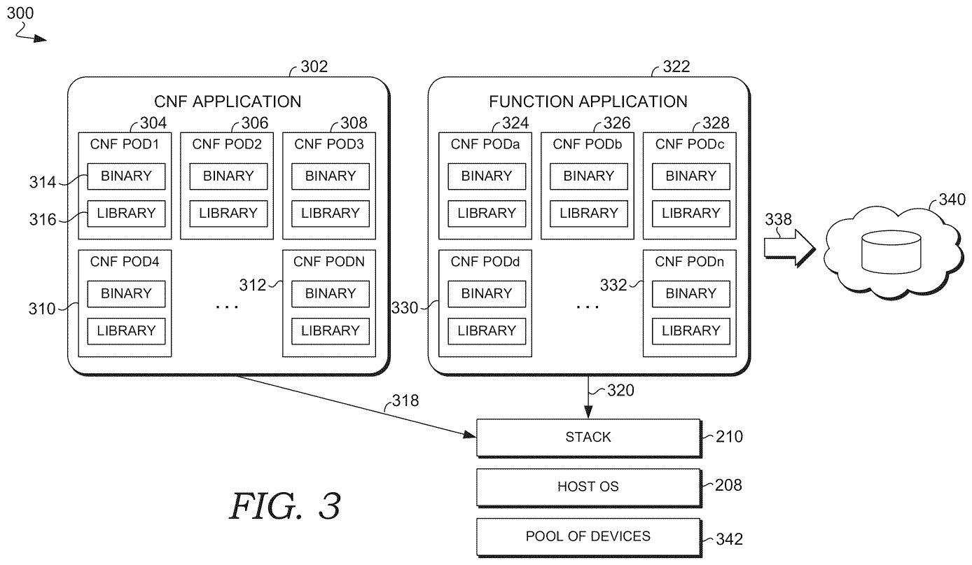

Continuing to FIG. 3, an example of a function application is illustrated in accordance with aspects herein. In the example illustrated in FIG. 3, a CNF application 302 and a function application 322 are illustrated as simplified, representative blocks. In some aspects, the CNF application 302 and the function application 322 may include different attributes.

The CNF application 302 may include a plurality of CNF pods (e.g., Kubernetes pods and/or containers, such as the one or more containers 206 of FIG. 2): a CNF POD1 304, a CNF POD2 306, a CNF POD3 308, a CNF POD4 310, and a CNF PODN 312. In this example, each of the CNF pods in the CNF application 302 may operate in binary 314 and may comprise a library 316. In FIG. 3, each CNF pod may have a single IP where there is a single pod, or multiple IPs associated with each respective pod of many. Each of the CNF pods may communicate with one another using internally facing IPs, in some instances.

For example, CNF POD4 310 may communicate with CNF POD2 306, and both CNF POD4 310 and CNF POD2 306 may share an identical IP—the same IP address for internally communicating between pods within the same container. In contrast, the CNF application 302 may communicate with another application on a separate Kubernetes cluster. In that case, there may be a second set of IPs that is external to the domain of the CNF application 302 that may allow the CNF application 302 and the other application to communicate with each other. As such, there are internal facing IPs within a container, and external facing IPs outside of a container. The internal facing IPs are generally hidden and undiscoverable, as previously described, without the aspects discussed herein.

In aspects, the CNF application 302 and the function application 322 may be parallel applications running on the same stack (e.g., stack 210). As such, the function application 322 may include a CNF PODa 324, a CNF PODb 326, a CNF PODc 328, a CNF PODd 330, and up to a CNF PODn 332. Similar to each of the CNF pods in the CNF application 302, the CNF pods in the function application 322 may operate in binary and comprise a library. In some aspects, the function application 322 may be a CNF application having a plurality of containers, and each container may comprise a plurality of IP addresses for externally communicating outside of the CNF application. Notably, in the absence of the aspects discussed herein, the internally facing IPs of the CNF application 302 are hidden from the function application 322, and vice versa, as well as being hidden from any other applications.

For the function application 322 to communicate with the CNF application 302, the communications may go through the stack 210, as only the externally facing IP of the CNF application 320 is available. As can be seen in the example illustrated in FIG. 3, the CNF application 302 is stored on the stack 210 (e.g., represented by an arrow 318), and the function application 322 may access the information associated with the CNF application 302 by analyzing the stack 210 (e.g., represented by an arrow 320). Accordingly, in aspects, communications may go through the stack 210, in order to enable communications between the containerized applications. Furthermore, the communications between the CNF application 302 and the function application 322 may be facilitated by the host OS 208 and across a pool of devices 342. In one example, the pool of devices 342 may be more than one user device 106. In another example, the pool of devices 342 may be a pool of hardware servers (e.g., any number of hardware servers) with a host OS (e.g., such as the host OS 208) installed on the hardware servers. In this example, a Kubernetes stack (e.g., such as stack 210) may be utilized on one of the hardware servers to enable a user to spawn any container in the Kubernetes stack and/or spawn any other device in the pool of devices 342. As such, the present disclosure may be performed for each of a plurality of servers, and each server of the plurality of servers may run the host OS 208 having a corresponding external-facing IP address. These servers may correspond to a physical server rack (e.g., such the rack 202).

However, in some aspects, the function application 322 is a discovery application within the rack, such as the IP discovery engine 108, for example. In such instances, the discovery application is configured to, via the one or more processors, automate IP discovery within overlaid applications (e.g., containerized applications) to discover the internally facing IP addresses of the pods in the CNF application 302. In another example, the IP discovery engine 108 may be located and/or operated on the user device 106, and the IP discovery engine 108 may communicate with the function application 322 to facilitate aspects of the present disclosure. In one such aspect, the IP discovery engine 108 may provide the function application 322 with the capability to identify the IPs associated with the CNF application 302. Thus, the IP discovery engine 108 may operate on a user device 106 or within the rack on a server.

Using the IP discovery engine 108 in this example, the function application 322, via the command requester 110, may communicate with the stack 210 through API 112 (e.g., illustrated by the arrow 320) by generating a request for the attributes of any and/or all of the CNF pods associated with the CNF application 302 (e.g., to request the attributes of the Kubernetes cluster), including attributes such as externally facing and internally facing IPs. In aspects, the request is a computerized command that is communicated through a host level OS (e.g., the host OS 208). Once the communication is initiated, the function application 322 may operate automatically (e.g., sends the request, retrieves the attributes, and communicates the attributes to the cloud). In some aspects, the command requester 110 contacts the API server (e.g., a Kubernetes API server), asking for a list of hidden or internally facing IPs that are residing in all of the CNF pods (e.g., all of the containers) associated with the CNF application 302.

As such, the command requester 110 sends calls to the API 112 to request information related to the Kubernetes pods. In some examples, the call (e.g., a computerized command) is a Kubectl command. The Kubectl type command may be provided to the function application 322, and the stack 210 may include a set of standardized commands (e.g., associated with Kubernetes). When the API 112 is called, the stack 210 analyzes a local database (e.g., database 120) and provides the requested information (e.g., the attributes of pods and/or containers of the CNF application 302) to the function application 322. Accordingly, the request sent by the command requester 110 is a computerized command that asks for specific information (e.g., attributes of the CNF application 302, including hidden, internally facing pod-specific IPs).

In other words, the Kubectl command is used by the command requester 110 to cause the attribute retriever 114 of the API 112 to fetch the information associated with the CNF pods (e.g., fetch the IPs on the pods). As such, the function application 322 may run a command to pull out the data associated with the CNF application 302. Notably, the attribute retriever 114 may extract the ownership of each IP (e.g., IP address) associated with the CNF pods. In addition to extracting the IPs, the attribute retriever 114 may pull namespaces, deployment sets, and any other information associated with the CNF application 302. Once the attribute retriever 114 fetches the information (e.g., data) associated with the CNF pods, the API 112 provides the information to the function application 322. Accordingly, the data fetched from the stack 210 by the attribute retriever 114 goes directly to the function application 322.

Once the function application 322 retrieves the attributes (e.g., via the attribute retriever 114), the attribute communicator 116 may publish this information (e.g., the attributes, including the IPs associated with the CNF application 302) to a CMDB cloud 340 (e.g., illustrated by arrow 338). As such, the function application 322 may publish the data to the external CMDB cloud 340. The information that is published to the CMDB cloud 340 may be displayed on a graphical user interface (GUI). When the data is transmitted to the CMDB cloud 340, the data may be transformed. For example, the data may be transformed into a format that, when displayed on the GUI, an MNO may readily review and/or read the data. Accordingly, in some aspects, the information pulled via the attribute retriever 114 is not stored in the function application 322, but rather the information is communicated to (e.g., via the attribute communicator 116) and stored on the CMDB cloud 340. Said differently, the attribute retriever 114 pulls the list of IPs from the CNF application 302, and the attribute communicator 116 publishes the list of IPs in the CMDB cloud 340. In some examples, the data published in the CMDB cloud 340 may be transformed by the function application 322 in a way that an MNO can use to add ownership information to the data.

In some aspects, the ownership assigner 118 may list the ownership for each IP in the CMDB cloud 340 that was published by the attribute communicator 116. In other words, the IPs may be “live” in the CMDB cloud 340 (e.g., displayed in the GUI as active addresses), and the ownership assigner 118 may organize the IPs in a list format or any other query-able format. Because the list of ownership is published in the CMDB cloud 340, an MNO may review the list of ownership in the CMDB cloud 340 and determine if there is anything further that the an MNO would like to do. For example, an MNO my employ endpoint detection and/or anomaly detection (e.g., for cybersecurity purposes), because the MNO is able to now pinpoint ownership of the specific IPs. Accordingly, every IP address in the received attributes may be assigned an owner identifier and an owner group identifier in the database (e.g., in a telecommunications network).

In some examples, the owner of an application may use the ownership assigner 118 to add ownership information to the entries published in the CMDB cloud 340. In an example, an owner of a particular application (e.g., the CNF application 302 or the function application 322) may claim ownership of IPs associated with the application. In some examples, the ownership can be claimed manually or automatically, depending on the mechanism that is employed by the owner. However, regarding the manual process, it may be impractical for an MNO to add ownership to thousands of IPs associated with potentially thousands of applications. As such, the automated ownership method may be helpful. Once the ownership is claimed (e.g., via the ownership assigner 118), the ownership of the IPs becomes data for cyber security teams to use for any quantity, type, or kind of cyber security compliance reasons or regulations in the asset management space.

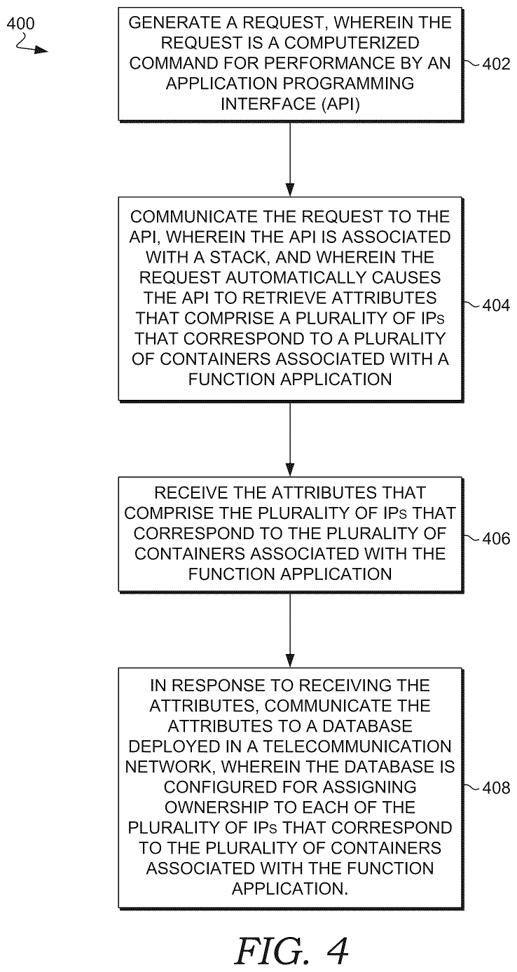

Turning now to FIG. 4, a flowchart for an example method 400 to be performed in accordance with aspects herein, such as through components shown in FIG. 1. The method 400 may be a computer-implemented method, in various aspects, for example, using non-transitory computer-readable storage medium having computer-readable program code portions embodied therein that are used to implement the method 400. For example, the computer-readable program code portions may include one or more executable portions configured to perform the method 400, in aspects.

Generally the method 400 may be performed by an application, such as the application 204 of FIG. 2. In some instances, the method 400 may be facilitated by the IP discovery engine 108 of FIG. 1. At block 402, the application generates a request, wherein the request is a computerized command for performance by an API, according to any one or more aspects described with respect to FIGS. 1-3. At block 404, the application communicates the request to the API, wherein the API is associated with a stack, and wherein the request automatically causes the API to retrieve attributes that comprise a plurality of IPs that correspond to a plurality of containers associated with a function application, according to any one or more aspects described with respect to FIGS. 1-3. At block 406, the application receives the attributes that comprise the plurality of IPs that correspond to the plurality of containers associated with the function application, according to any one or more aspects described with respect to FIGS. 1-3. At block 408, in response to receiving the attributes, the application communicates the attributes to a database deployed in a telecommunication network, wherein the database is configured for assigning ownership to each of the plurality of IPs that correspond to the plurality of containers associated with the function application, according to any one or more aspects described with respect to FIGS. 1-3.

Turning to FIG. 5, an example computing device 500 is shown that is suitable for use in implementations of the disclosure. Computing device 500 is but one example of a suitable computing environment and is not intended to suggest any limitation as to the scope of use or functionality of the disclosure, and nor should computing device 500 be interpreted as having any dependency or requirement relating to any one or combination of components illustrated.

The implementations of the present disclosure may be described in the general context of computer code or machine-useable instructions, including computer-executable instructions such as program components being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 5, computing device 500 includes bus 510 that directly or indirectly couples with the following devices: memory 512, one or more processors 514, one or more presentation components 516, input/output (I/O) ports 518, I/O components 520, and power supply 522. Bus 510 represents what may be one or more buses (such as an address bus, data bus, or combination thereof). Although the devices of FIG. 5 are shown with lines for the sake of clarity, in reality, delineating various components is not so clear, and metaphorically, the lines would more accurately be grey and fuzzy. For example, one may consider a presentation component such as a display device to be one of I/O components 520. Also, processors, such as one or more processors 514, have memory. Distinction is not made between such categories as “workstation,” “server,” “laptop,” “handheld device,” etc., as all are contemplated within the scope of FIG. 5 and refer to “computer” or “computing device.” Computing device 500 typically includes a variety of computer-readable media that can be accessed by computing device 500.

Memory 512 includes computer storage media in the form of volatile and/or non-volatile memory. Memory 512 may be removable, non-removable, or a combination thereof. Examples of memory include solid-state memory, hard drives, optical disc drives, etc. Computing device 500 includes one or more processors 514, which read data from various entities such as bus 510, memory 512, or I/O components 520. One or more presentation components 516 present data indications to a person or other device. Examples of one or more presentation components 516 include a display device, speaker, printing component, vibrating component, etc. I/O ports 518 allow computing device 500 to be logically coupled to other devices including I/O components 520, some of which may be built into computing device 500. Illustrative I/O components 520 include a microphone, joystick, game pad, satellite dish, scanner, printer, wireless device, etc.

Many different arrangements of the various components depicted, as well as components not shown, are possible without departing from the scope of the claims below. Aspects of our technology have been described with the intent of being illustrative rather than restrictive. Alternative aspects will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A method for automated Internet Protocol (IP) discovery within overlaid applications, the method comprising:
generating a request, wherein the request is a computerized command for performance by an application programming interface (API);
communicating the request to the API, wherein the API is associated with a stack, and wherein the request automatically causes the API to retrieve attributes that comprise a plurality of IPs that correspond to a plurality of containers associated with a function application;
receiving the attributes that comprise the plurality of IPs that correspond to the plurality of containers associated with the function application; and
in response to receiving the attributes, communicating the attributes to a database deployed in a telecommunication network, wherein the database is configured for assigning ownership to each of the plurality of IPs that correspond to the plurality of containers associated with the function application.

2. The method of claim 1, wherein the request is communicated through a host level operating system.

3. The method of claim 1, wherein the computerized command is a Kubectl type command.

4. The method of claim 1, wherein the function application is a cloud native network function application having a plurality of containers, wherein each container comprises a plurality of IP addresses for external communications outside of the plurality of containers.

5. The method of claim 1, wherein the stack is a Kubernetes stack.

6. The method of claim 1, wherein in the telecommunication network, every IP address in the received attributes is assigned an owner identifier and an owner group identifier in the database.

7. The method of claim 6, wherein the method is performed for each of a plurality of servers, wherein each server is running a host level operating system having a corresponding external-facing IP address.

8. The method of claim 7, wherein the plurality of servers correspond to a physical server rack.

9. One or more non-transitory computer readable media storing instructions that when executed via one or more processors perform a computerized method for Internet Protocol (IP) discovery, the media comprising:
generate a request, wherein the request is a computerized command for performance by an application programming interface (API);
communicate the request to the API, wherein the API is associated with a stack, and wherein the request automatically causes the API to retrieve attributes that comprise a plurality of IPs that correspond to a plurality of containers associated with a function application;
receive the attributes that comprise the plurality of IPs that correspond to the plurality of containers associated with the function application; and
in response to receiving the attributes, communicate the attributes to a database deployed in a telecommunication network, wherein the database is configured for assigning ownership to each of the plurality of IPs that correspond to the plurality of containers associated with the function application.

10. The media of claim 9, wherein the function application is a cloud native network function application have a plurality of containers, wherein each container comprises a plurality of IP addresses for external communications outside of the plurality of containers.

11. The media of claim 9, wherein the stack is a Kubernetes stack.

12. The media of claim 9, wherein in the telecommunication network, every IP address in the received attributes is assigned an owner identifier and an owner group identifier in the database.

13. The media of claim 12, wherein the method is performed for each of a plurality of servers, wherein each server is running a host level operating system having a corresponding external-facing IP address.

14. The media of claim 13, wherein the plurality of servers correspond to a physical server rack.

15. A system for Internet Protocol (IP) address identification for containers, the system comprising:
a physical server rack comprised of a plurality of servers, each of the plurality of servers comprising a host level operating system and a plurality of containers, wherein the physical server rack is deployed in a telecommunication network;
a discovery application configured for, via one or more processors:
generating a request, wherein the request is a computerized command for performance by an application programming interface (API);
communicating the request to the API, wherein the API is associated with a stack, wherein the request automatically causes the API to retrieve attributes that comprise a plurality of IPs that correspond to the plurality of containers associated with a function application;
receiving the attributes that comprise the plurality of IPs that correspond to the plurality of containers associated with the function application; and
in response to receiving the attributes, communicating the attributes to a database deployed in the telecommunication network, wherein the database is configured for assigning ownership to each of the plurality of IPs that correspond to the plurality of containers associated with the function application.

16. The system of claim 15, wherein the host level operating system utilizes LINUX.

17. The system of claim 15, wherein the computerized command is a Kubectl type command.

18. The system of claim 15, wherein the function application is a cloud native network function application, wherein each container comprises a plurality of IP addresses for external communications outside of the plurality of containers.

19. The system of claim 15, wherein the stack is a Kubernetes stack.

20. The system of claim 15, wherein in the telecommunication network, every IP address in the received attributes is assigned an owner identifier and an owner group identifier in the database.
